(19) United States
(12) Patent Application Publication
(10) Pub. No.: US 2008/0315842 A1
(43) Pub. Date: Dec. 25, 2008

(54) POWER ADAPTER DETECTION

(76) Inventors: Peter T. Li, Portland, OR (US); Don J. Nguyen, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/765,830

(22) Filed: Jun. 20, 2007

(51) Int. Cl. H02J 7/00

(52) U.S. Cl. 320/137

(57) ABSTRACT

According to some embodiments, an apparatus for power adapter detection is disclosed. The apparatus includes a first detection module to detect if a first signal from a power adapter is present and in a first voltage range, a second detection module to detect if a second signal from the power adapter is present and in a second voltage range, and a third module to permit a system to be powered by the power adapter if the first signal is present and in the first voltage range and if the second signal is present and in the second voltage range.

### BACKGROUND

Mobile computing devices may be powered by an external power source, such as an AC/DC power adapter. The power adapter may provide power to the computing device and may also charge the computing device's battery pack.

AC/DC power adapters for a mobile computing device, such as a notebook or laptop computer, may appear to be interchangeable. However, the use of a conventional or legacy power adapter with some mobile computing devices may cause damage to components in the mobile computing device or may not properly charge the battery of the mobile computing device.

### BRIEF DESCRIPTION OF THE DRAWINGS

A better understanding of embodiments of the present invention can be obtained from the following detailed description in conjunction with the following drawings, in which:

FIG. 1 is a block diagram of a circuit to couple a power adapter to a mobile computing device in accordance with some embodiments.

FIG. 2 is a schematic diagram of a circuit to couple a power adapter to a mobile computing device in accordance with some embodiments.

FIG. 3 is a schematic diagram of a circuit to couple a power adapter to a mobile computing device in accordance with some embodiments.

FIG. 4 is flow diagram showing a routine to couple a power adapter to a mobile system according to some embodiments.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment,” “an embodiment,” “example embodiment,” “various embodiments,” etc., indicate that the embodiments) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

Various embodiments of the invention may be implemented in one or any combination of hardware, firmware, and software. Embodiments may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

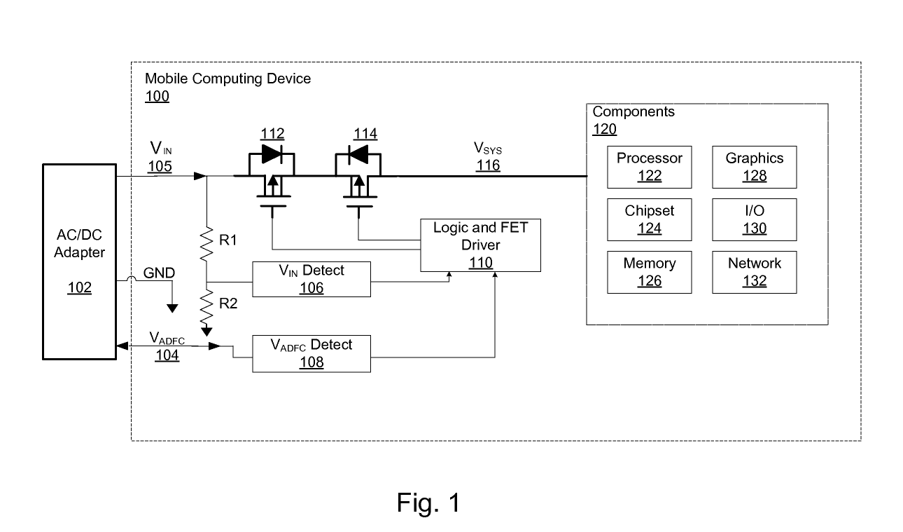

FIG. 1 shows a circuit to couple an AC/DC power adapter 102 to a mobile computing device 100 in accordance with some embodiments. The mobile computing system may be any mobile computing device, such as, but not limited to, a notebook or laptop computer, a handheld computing device, a cellular telephone, or any other portable computing device. In some embodiments, the mobile computing device 100 may include components 120, such as, but not limited to, a processor 122, chipset 124, memory 126, graphics controller 128, input/output (I/O) device(s) 130, and/or a wired or wireless network adapter 132.

In some embodiments, the AC/DC power adapter 102 may be an adapter that is enabled with Intel® Adaptive Mobile Power System (AMPS) technology. An AMPS compliant power adapter may have an output voltage, V_{IN} 105, which is controllable by the mobile computing device 100. An AMPS compliant power adapter may also have a control signal, V_{ADFC} 104 to provide adapter feedback and to control the output voltage of the adapter, V_{IN} 105. In other embodiments, the AC/DC power adapter 102 may be any adapter that has both a DC voltage bus (e.g., V_{IN} 105) to provide power to the mobile computing device 100 and a control signal (e.g., V_{ADFC} 104) coupled to the mobile computing device 100.

The mobile computing device 100 may include an adapter output voltage detection module 106 coupled to the power adapter 102 to detect whether the adapter output voltage 105 is present and in a predetermined voltage range. In some embodiments, the adapter output voltage detection module may be coupled to a voltage divider R1 and R2. The voltage divider may scale the adapter output voltage down for ease of detection circuit design. In some embodiments, the voltage range for the adapter output voltage may vary depending on the number of battery cells in the mobile computing device 100. In some embodiments, the values for R1 and R2 may be chosen in such a way that the ratio of (R1+R2)/R2 is equal to the number of battery cells in the mobile computing device. For example, for a 3-cell in series battery pack, R1 may be chosen as a 200 KOhm resistor and R2 may be chosen as a 100 KOhm resistor. The voltage range for the divided adapter output voltage may be between 1.8V and 5.0V per cell in some embodiments.

The mobile computing device may further include a control signal detection module 108 coupled to the power adapter 102 to detect whether the adapter control signal 104 is present and in a predetermined voltage range. To detect the presence of the control signal 104 a small current may flow from the mobile computing device 100 to the adapter 102. The voltage range for the adapter control signal may be between 1.1V and 4.9V in some embodiments.

A logic and FET (field effect transistor) driver module 110 may be coupled to the adapter output voltage detection module 106 and to the control signal detection module 108. If both the adapter output voltage 105 and the control signal 104 are present and in the proper voltage range, the logic and FET driver module 110 will close transistor switches 112 and 114, thus allowing the adapter output voltage 105 to be coupled to the system voltage 116. In some embodiments, transistor switches 112, 114 may be implemented with PMOS transistors, configured having an associated rectification component in the direction illustrated.

Thus, the power adapter 102 will provide power to the mobile computing device components 120 only if it is determined that both the power adapter voltage 105 and control signal 104 are present and in a proper voltage range.

If either detection module 106 or 108 determines that a signal is not present and/or is not in a predetermined voltage range, the logic and FET driver module 110 will not close switches 112 and 114. In this case, the adapter 102 will not provide power to the components 120 of the mobile computing device 100.

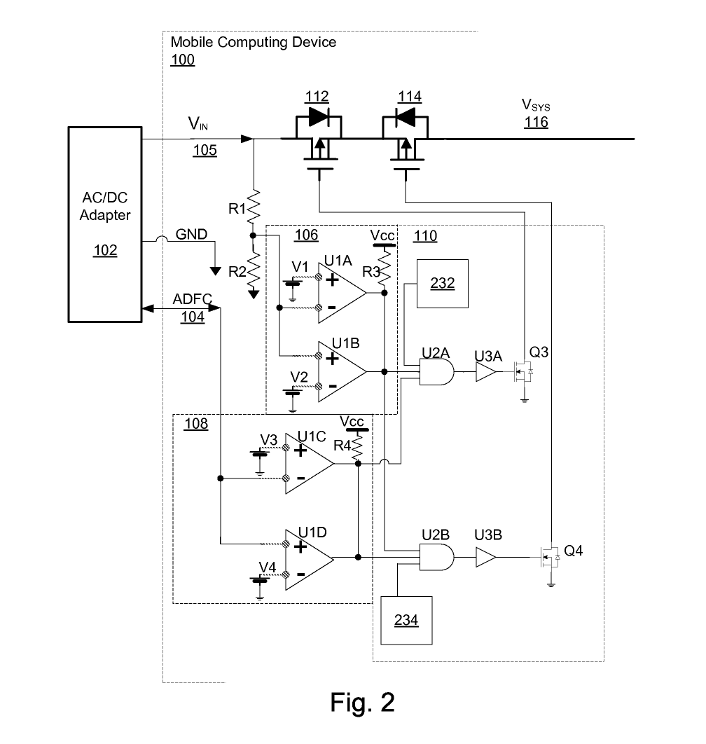

FIG. 2 is a circuit diagram illustrating example detection circuits 106, 108 and logic/FET driver module 110 for the system of FIG. 1 according to some embodiments. In some embodiments, the adapter output voltage detection circuit 106 and the control signal detection circuit 108 may each include two voltage comparators (U1A and U1B, U1C and U1D) coupled to each other. The voltage comparators may be powered by V_{CC}, which in some embodiments is 5V. The upper voltage threshold limit may be set as an input to a positive terminal of one of the voltage comparators in the detection circuit, e.g., V1, V3. The lower voltage threshold limit may be set as an input to a negative terminal of the other voltage comparator in the detection circuit, e.g., V2, V4. Thus, for a voltage-divided adapter output voltage range of 1.8V to 5.0V, the adapter output voltage detection circuit may have a V1 value of 5.0V and a V2 value of 1.8V. Similarly, for a control signal range of 1.1V to 4.9V, the adapter output voltage detection circuit may have a V3 value of 4.9V and a V4 value of 1.1V. In some embodiments, R3 and R4 may have a value of 10 KOhm.

The logic/FET driver module 110 may include two AND gates, U2A and U2B. The output of each AND gate may be buffered by buffers U3A and U3B, respectively, and may drive transistor switches Q3 and Q4. The inputs to each AND gate may include the outputs of each detection circuit, 106, 108. In some embodiments the output of a logic block 232, 234 within the logic/FET driver module 110 may also be input to each of the AND gates. Logic blocks 232, 234 may include, for example, current sensing circuits.

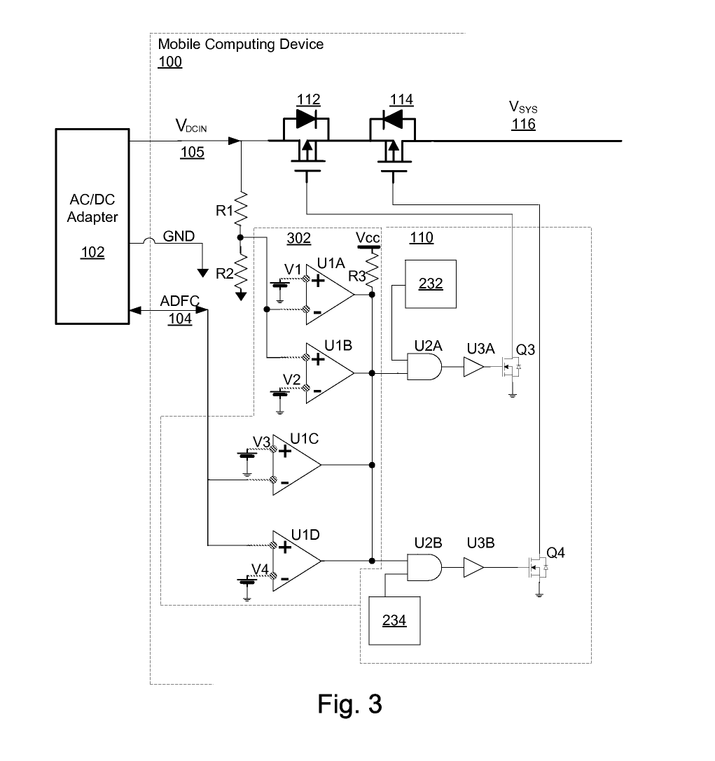

FIG. 3 is a circuit diagram illustrating a combined adapter output voltage and control signal detection circuit 302 and logic/FET driver module 110 for the system of FIG. 1 according to some embodiments. In some embodiments, two voltage comparators U1A, U1B may be coupled to each other to detect an adapter output voltage 105 in a predetermined range and two voltage comparators U1C, U1D may be coupled to each other to detect a control signal 104 in a proper range. The outputs of the voltage comparators may be connected, and may be an input to each of two AND gates U2A, U2B in a logic/FET driver module 110. In some embodiments the output of a logic block 232, 234 within the logic/FET driver module 110 may also be input to each of the AND gates. Logic blocks 232, 234 may include, for example, current sensing circuits.

While FIGS. 2 and 3 illustrate specific circuits that may be used to implement the detection modules and logic module of FIG. 1, it will be understood that other, different circuit design implementations may be used to achieve a similar result. Furthermore, although only two signals and their associated detection circuits are described herein, it should be recognized that additional signals may be detected and required to be in a proper range before coupling the power adapter output voltage to the system voltage.

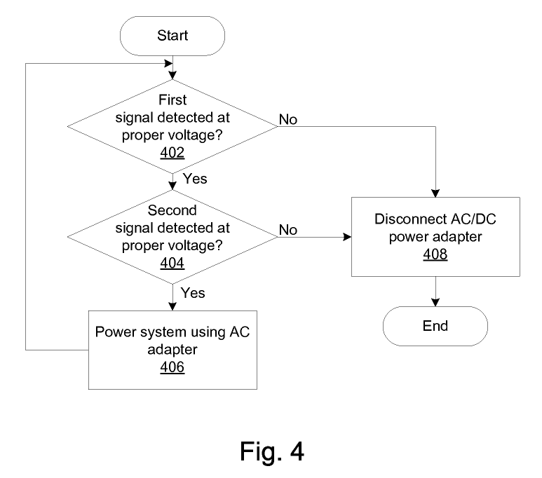

FIG. 4 is a flow diagram illustrating a routine to couple a power adapter to a mobile computing device according to some embodiments. The routine may begin when a power adapter is connected to a computing device or when the computing device is powered on.

At 402, a determination is made whether a first signal is present and in a proper voltage range. In some embodiments, the first signal may be a voltage output from the power adapter. If the first signal is not present, or if it is outside of the predetermined voltage range, the power adapter will not be allowed to provide power to the system, as shown in block 408. The power adapter may be prevented from providing power to the system by switches that remain open unless certain conditions are met (e.g. one or more signals present and in proper range).

At 404, a determination is made whether a second signal is present and in a proper voltage range. In some embodiments, the second signal may be a control signal. If the second signal is not present, or if it is outside of the predetermined voltage range, the power adapter will not be allowed to provide power to the system, as shown in block 408. The power adapter may be prevented from providing power to the system by switches that remain open unless certain conditions are met (e.g. one or more signals present and in proper range).

At 406, if both the first signal and the second signal are present and in the proper voltage range(s), the power adapter will be allowed to provide power to the system. One or more switches, such as transistor switches 112 and 114 of FIG. 1, may be closed, thus coupling the adapter output voltage (V_{IN}) to the system voltage (V_{SYS}).

The system may continuously monitor both the first and second signals to ensure that they are present and in the proper ranges. If at any time during system operation one of the signals from the power adapter is no longer present or goes out of range, the power adapter may be disconnected from the system by the opening of one or more transistor switches.

Thus, power adapter detection is disclosed in various embodiments. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

I claim:

1. An apparatus, comprising:
a first detection module to detect if a first signal from a power adapter is present and in a first voltage range;
a second detection module to detect if a second signal from the power adapter is present and in a second voltage range; and
a third module to permit a system to be powered by the power adapter if the first signal is present and in the first voltage range and if the second signal is present and in the second voltage range.

2. The apparatus of claim 1, wherein the third module is further to prevent a system from being powered by the power adapter if one of the first signal and the second signal are not present.

3. The apparatus of claim 2, wherein the third module is further to prevent a system from being powered by the power adapter if one of the first signal and the second signal are not in the first voltage range and the second voltage range, respectively.

4. The apparatus of claim 1, wherein the first signal is a voltage output from the power adapter.

5. The apparatus of claim 1, wherein the second signal is a control signal from the power adapter.

6. The apparatus of claim 1, further comprising a voltage divider coupled to the first detection module.

7. The apparatus of claim 1, wherein the first detection module and the second detection module each comprise two voltage comparators, and wherein the third module comprises two AND gates, wherein each AND gate is coupled to a buffer and a transistor switch.

8. A method comprising:
detecting a first signal and determining if the first signal is in a first voltage range;
detecting a second signal and determining if the second signal is in a second voltage range; and
if one of the first signal and the second signal are not in the first voltage range and the second voltage range, respectively, disconnecting components in a system from a power adapter.

9. The method of claim 8, further comprising if the first signal is in the first voltage range and the second signal is in the second voltage range, respectively, providing power to the system from the power adapter.

10. The method of claim 9, wherein the first signal is a voltage output from the power adapter.

11. The method of claim 10, wherein the second signal is a control signal from the power adapter.

12. The method of claim 8, wherein detecting the second signal comprises generating a current to flow from the system to the power adapter.
